(19) United States
(12) Patent Application Publication
(10) Pub. No.: US 2014/0072752 A1
(43) Pub. Date: Mar. 13, 2014

(54) COMPOSITE PANEL AND PROCESS FOR PRODUCING SAME

(71) Applicant: SOLIGHT, Sainte Sigolene (FR)

(72) Inventors: Vincent MOULIN, Ansouis (FR); Rainer DUCHENE, Natick, MA (US)

(73) Assignee: SOLIGHT, Sainte Sigolene (FR)

(21) Appl. No.: 14/077,466

(22) Filed: Nov. 12, 2013

Related U.S. Application Data
(63) Continuation of application No. PCT/EP2012/058828, filed on May 11, 2012.

(30) Foreign Application Priority Data
May 11, 2011 (FR) 1154083

(51) Int. Cl. B32B 3/06; B32B 37/02

(52) U.S. Cl. CPC B32B 3/06; B32B 37/02
USPC 428/58; 156/60; 156/220; 156/226

(57) ABSTRACT

The invention relates to a composite panel, including: a plurality of individual composite panels, each having at least one core and two surface skins and each being assembled along an assembly zone with at least one neighbouring individual panel by one of its sides, a reinforcement zone formed in the surface skins on either side of the assembly zone and along this zone, a strip of reinforcing material positioned over said assembly zone of a panel with the neighbouring panel or panels, in each reinforcing zone.

### CROSS REFERENCE TO RELATED APPLICATIONS

This application is a continuation of International Patent Application Number PCT/EP2012/058828 filed on 11 May 2012 which claims priority to French Patent Application Number 1154083 filed on 11 May 2011, both of said applications being herein incorporated by reference in their entirety.

### TECHNICAL FIELD

The present invention relates to a composite panel, that can notably be used in the production of large surfaces, for example with a length greater than 10 m and a width of between 1 m and 3 m or between 1 m and 10 m, for a thickness of up to 10 or so centimeters.

It also relates to a composite panel that can easily be used in producing three-dimensional objects, having folding or curving or bending zones.

It also relates to a method for producing a composite panel.

It also relates to novel individual panel structures. These individual panels can, for example, be used in the context of the composite panel structure according to the invention, or in the context of a method for producing a composite panel according to the invention.

### BACKGROUND

A panel structure is known, illustrated in FIG. 1A, that has a core, or a kernel, 2, inserted between two layers 4, 6 called “skins”. Typically, as can be seen in the plan view of FIG. 1B, such a panel has a width I of approximately 1 m, and a length L of between, for example, 2 m and 8 m.

There are techniques for joining such panels, for producing large surfaces, but these do not give satisfaction, whether for esthetic reasons, because of the coupling zones between the adjacent panels, or because of the difficulty in producing three-dimensional shapes with such panels resulting from the joining of individual composite panels.

One example of application of this type of panel relates to the production of bodywork elements, for example the body of a trailer or of a truck. FIGS. 2A and 2B (the latter being a view according to the arrow marked in FIG. 2A) show, very schematically, the structure of a trailer 10, when stopped. This trailer consists mainly of side panels 12, 12′, 14, each forming a side surface or a top surface, and the assembly, after joining, delimiting the volume inside which the goods will be able to be stored. FIG. 2A shows, more specifically, lines 12₁, 12₂, 12₃, which are lines along which adjacent panels are joined to form a continuous surface, here the side surface 12. After each of the surfaces 12, 12′, 14 has been constructed, the latter are joined using angle brackets 16, 16′. This joining therefore entails the use of additional parts, in order to produce a structure which is not only flat, but which has a three-dimensional construction.

It will be understood that this type of joining takes a long time to produce and entails steps of aligning large surfaces such as the surfaces 12 and 14, which are, by their size, not easy to handle.

There is therefore the problem of finding a novel technique for producing composite panels, in particular suitable for producing large surfaces, which does not present the drawbacks explained above.

A structure that makes it possible to produce three-dimensional surfaces simply, without using additional parts such as the angle brackets commonly used in the known structures, is particularly sought.

A novel composite panel structure is also sought that is reinforced and more solid than the panels of known type, in order to withstand compression and extension stresses, notably when the panels are joined to form large surfaces.

### BRIEF SUMMARY

The present application describes such a composite panel structure, comprising:
a plurality of individual composite panels, each comprising at least one core and two surface walls or skins and each being joined with at least one adjacent individual panel by one of its sides,
an indented, or thinned, or recessed, zone, on either side of a joining zone or line, and along the latter,
a strip of reinforcing material positioned on said joining zone or line joining a panel with the adjacent panel or panels, in each indented, or recessed, zone.

Such a composite panel may also comprise one or more notches, each being positioned in any direction relative to said strips of material, for example parallel or perpendicular thereto, one or more notches forming one or more folding zone(s) and making it possible to fold the panel according to the direction of this or these notches.

A method for manufacturing a composite panel is also described, comprising:

a)—joining a plurality of individual composite panels, each comprising at least one core and two surface skins, each panel being joined with at least one adjacent individual panel by one of its sides,
b)—fixing a strip of reinforcing material on each joining zone or line joining a panel with the adjacent panel or panels, in a corresponding indented, or thinned, or recessed, zone, on either side of the joining zone or line and along the latter.

Each strip is fixed by heat, without adding glue or adhesive material.

Each strip is preferably made of a textile material, even more preferably of the same nature as that of the skins. Each strip is uniform, and does not entail any injection operation.

An indented, or thinned, or recessed, zone can be obtained by forming a groove in the skin, by eliminating material therefrom, over a part of its thickness. In this case, the core of each of the panels remains of substantially constant thickness.

According to another embodiment, an indented, or thinned, or recessed, zone can be obtained by exercising a pressure, on each of the panels to be joined, for example in a heating operation, the thickness of the corresponding portion of the core in, or under, this zone being reduced relative to the adjacent zones not having been subjected to said pressure. In this case, there is no removal of material from the skin.

Such a method can also comprise the formation of at least one notch, or of a zone in which material has been eliminated, in at least one of the panels, in any direction relative to said strips of material, for example parallel or perpendicular thereto, this notch making it possible to fold the panel according to its direction. This notch zone or zone of elimination of material can penetrate into the core of the panel or panels.

A method is also described for producing a three-dimensional shape comprising a plurality of composite panels, comprising the implementation of the above method and described in the present application, followed by a step of folding along at least one of said notches; generally, a fold will be made along one or more notch zones. It is also possible to join together a number of duly produced three-dimensional shapes.

A method for manufacturing a composite panel or for producing a three-dimensional shape may also comprise the elimination of a zone of material, for example by cutting, in at least one of the individual panels, before folding.

A flash elimination can be performed after the panels have been joined.

After fixing the strips of reinforcing materials, it is also possible to cover the assembly with, on each side of the duly produced structure, at least one external sheet, for example of polypropylene.

In a method and/or a device according to the invention, a composite panel as described above can have:
a width, measured in a direction parallel to the strips of reinforcing material, of between 0.5 m and 5 m or 10 m,
and/or a length, measured in a direction perpendicular to the strips of reinforcing material, of between 1 m and 20 m and/or at least equal to 5 m or 10 m,
and/or a thickness, measured between the external surfaces of the surface walls, of between 5 mm and 100 mm.

Furthermore, a method and/or a device as described above can comprise one or more of the following features.

The core of such an individual composite panel can comprise at least one honeycomb layer and/or layer of polypropylene foam.

The surface walls or skins are, for example, of polypropylene, possibly reinforced by glass or any other type of reinforcement.

As a variant, the structure of an individual panel can comprise a textile layer, positioned on either side of the core of the panel, and an external layer of polypropylene, each textile layer being positioned between the core of the panel and an external layer.

The core of such an individual composite panel can be hybrid, comprising at least two layers of different natures, for example comprising a first layer of foam, a second honeycomb layer, and a third layer of foam.

Such a composite panel can also comprise external sheets, for example of polypropylene, covering the skins and the strips of reinforcing material.

The external surface of the reinforcing strips can be flush with the external surface of the adjacent panels, or protrude from or be raised relative to this surface.

An individual panel structure is also described in the present application that can be used notably in combination with a method, or with a composite panel structure, which has just been described.

Such an individual panel comprises at least one core and two surface walls or skins.

The core can comprise at least one honeycomb layer and/or layer of polypropylene foam.

The surface walls or skins are, for example, of polypropylene, possibly reinforced by glass or any other type of reinforcement.

As a variant, the structure of an individual panel can comprise a textile layer, positioned on either side of the core of the panel, and an external layer, for example of polypropylene, each textile layer being positioned between the core of the panel and an external layer.

The core of such an individual panel can be hybrid, comprising at least two layers of different natures, for example comprising a first layer of foam, a second honeycomb layer, and a third layer of foam.

Such a composite panel can also comprise external sheets, for example of polypropylene, covering the skins.

### BRIEF DESCRIPTION OF THE DRAWINGS

The present invention will be better understood on reading the description of exemplary embodiments given below, in a purely indicative and nonlimiting manner, by referring to the appended drawings in which:

FIGS. 1A and 1B schematically represent a known panel structure,

FIGS. 2A and 2B schematically represent a structure of a bodywork element produced according to a known technique,

FIGS. 3A-3C represent novel structures obtained by joining individual panels,

FIG. 4 also represents a novel composite panel structure, obtained by joining individual panels,

FIGS. 5A-5C and 6A-6B represent novel structures, obtained by joining individual panels, these structures being able to be folded,

FIG. 7 represents a novel composite panel structure, obtained by joining individual panels, this structure being able to be folded,

FIGS. 8A-8B represent a three-dimensional shape, produced with a foldable composite panel (FIG. 8A) and a joining of two three-dimensional shapes (FIG. 8B),

FIGS. 9A-9D illustrate the concepts of edges, open or closed, of an individual panel,

FIGS. 10A-10D illustrate a way of carrying out the welding of two panels,

FIGS. 11A-11C illustrate how it is possible to eliminate, or deflash, excess material after welding,

FIGS. 12A-12E and 13A-13D illustrate the reinforcing of the welding zones,

FIGS. 14A-14C illustrate individual panel structures.

### DETAILED DESCRIPTION

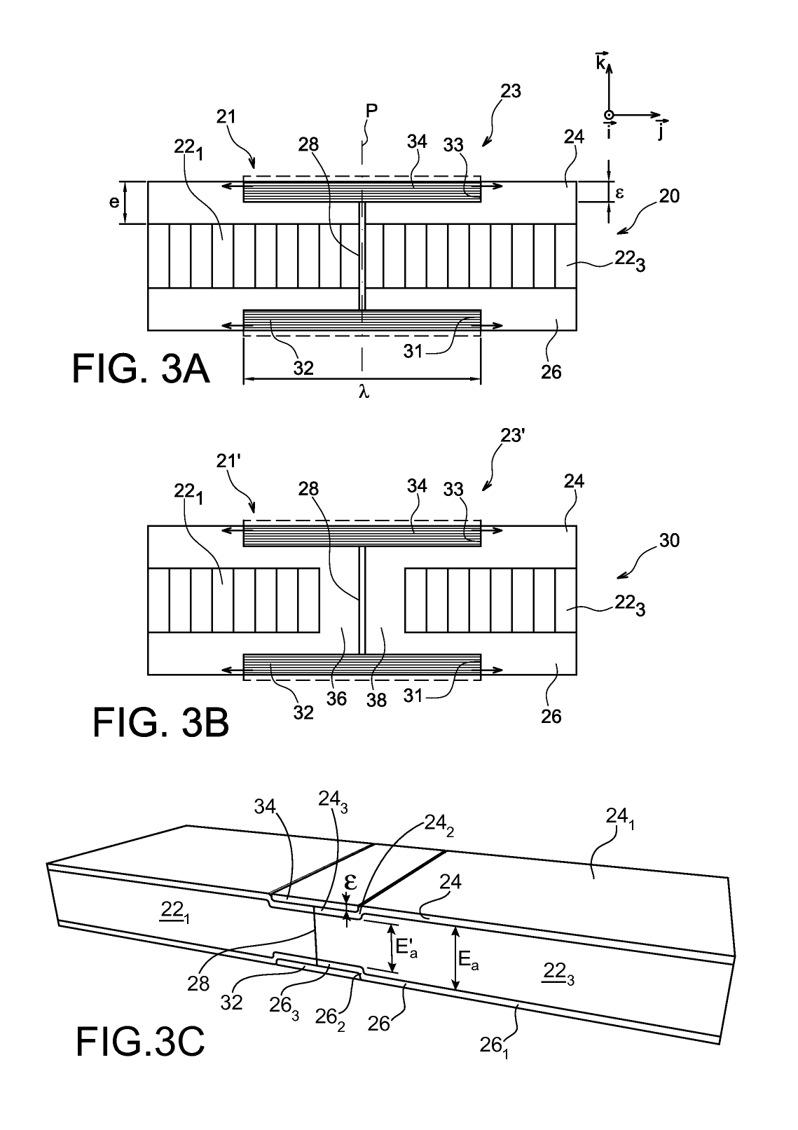

Examples of novel structures resulting from the joining of individual panels are illustrated in FIGS. 3A, 3B and 3C.

In the different figures, an orthogonal reference frame Oijk is used.

Moreover, given the dimensions obtained by a plurality of joined panels, the expression “plane of the panel or panels” will be used to denote a plan extending on one of the external surfaces of the assembly obtained. This is the plane Oij or a plane parallel thereto. The sides of the panel extend in a plane perpendicular to Oij; in particular, the sides that are joined at the joining zone 28 are in the plane Oik.

The structure of FIG. 3A represents two panels 21, 23 joined by a welding or thermowelding zone, or line, 28, each panel comprising a core (or a kernel) 22₁, 22₃ enclosed on either side by a skin 24, 26. The welding is done between two sides of each of the panels which are situated at right angles to the plane of these panels (in the direction indicated above). The panels are joined edge to edge, with no intermediate element between two joined adjacent edges.

The core consists, for example, of a honeycomb structure, the cells of which extend in a direction substantially perpendicular to each of the planes defined by the plane of the panels or the lateral skins 24, 26. Examples of materials that can form the core of each of the panels will be seen later.

It can also be seen that, in each of the skins 24, 26, a notch, or a groove, 31, 33, has been formed in a zone which overlaps the joining zone 28. The depth ε of each of the notches is less than the thickness e of each of the skins. e is, for example, between 0.3 mm and 5 mm. ε can be between 0.1 e and 0.7 e, and is preferably roughly equal, or equal, to 0.5 e.

Each notch has a width λ substantially between 10 mm and 100 mm, for example 40 mm, and is positioned substantially symmetrically on either side of a plane P defined by the joining zone 28 of the two panels. Each notch being in a direction perpendicular to each of FIGS. 3A and 3B, along each of the joined sides of each of the panels. In each notch there is positioned a reinforcing strip 32, 34, the external surface of which is flush with the external surface of the corresponding skin 24, 26 in which it is produced. As a variant (shown by broken lines in FIGS. 3A and 3B), the external surface of each reinforcing strip extends above the external surface of the corresponding skin 24, 26.

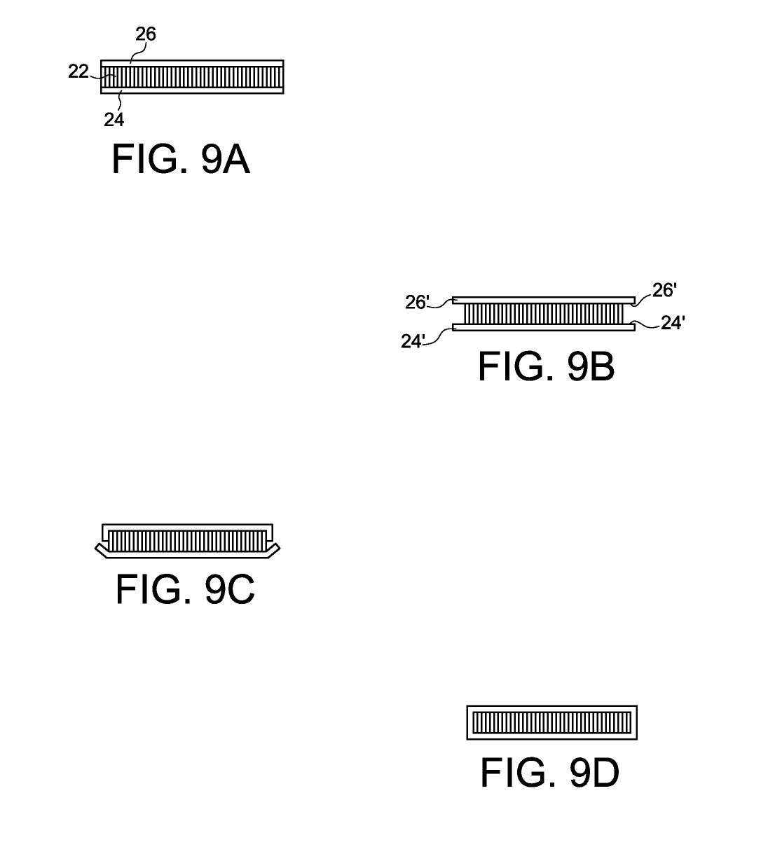

FIG. 3B represents a case where the panels used are of closed structure type. The difference between the structure of FIG. 3A and that of FIG. 3B therefore lies in the presence, in the latter, of edges 36, 38, on either side of the welding zone 28, because the panels are of the type with “closed” edges (this type of structure will be described in more detail later, in conjunction with FIGS. 9A-9D), whereas the panels of FIG. 3A have open edges. For the rest, the same numerical references are used in these figures, these references designating therein identical elements.

In the embodiments described above, notably in conjunction with FIGS. 3A and 3B, the external surface of each of the skins remains planar, like the internal surface, which is in contact with, or which is turned toward, the core 22₁, 22₃. The thickness of the latter remains also substantially constant, including after positioning of the reinforcing strips 32, 34.

FIG. 3C, in which numeric references identical to those of FIGS. 3A and 3B designate therein identical or similar elements, represents a case where there is no groove in the skins 24, 26. Each reinforcing strip is applied by juxtaposing it on, or against, the skins 24, 26, without grooves, then by applying a pressure, perpendicular to the plane Oij of the panels, toward the zone in which the reinforcing element has to be inserted. A detailed production method is described later. Because of this, the core 22₁, 22₃ is compressed between the two portions of the skins 24, 26 onto which the strips 32, 34 are pressed. This applies also to the case of a panel with closed structure, like that of FIG. 3B. The surface of the skin is therefore incurved toward the interior of the corresponding panel. The skin therefore has, outside the joining zones, a first portion 24₁, 26₁ which is planar. It also comprises a transition zone 24₂, 26₂ toward the joining zone, this transition zone being incurved toward the interior of the panel. Finally, it comprises a second planar portion 24₃, 26₃, but set back relative to the first portion.

Let Eₐ be the thickness of the core in the zones in which no reinforcing strip is positioned. Unlike the case of FIGS. 3A and 3B (where the core then has a constant thickness), the core has, in the zones where the reinforcing strips 32, 34 are positioned, a thickness E′ₐ<Eₐ. However, moreover, there has been no need to eliminate material from the skins 24, 26.

If the reinforcing strips 32, 34, of thickness c, have an external surface which is flush with the external surface of the corresponding skin 24, 26, then the following substantially applies: 2ε+E′ₐ≈Eₐ. As a variant, the external surface of each reinforcing strip extends above the external surface of the corresponding skin 24, 26. According to one example, if e is the thickness of the skin, then, in each reinforcing block, the thickness of the material, on either side of the core, is approximately e+ε. It is possible to have, for example, e=ε, that is to say that the thickness of the reinforcing strip is substantially equal to the thickness of the skin. According to one example, if the latter is approximately equal to 0.7 mm, then, in each reinforcing zone, the thickness of the skin and of the reinforcing strip reaches approximately 1.4 mm.

In all cases, each strip will make it possible to reinforce the structure when a tension, as schematically represented in FIG. 3A by arrows positioned on either side of the strips 32, 34 is exerted, as a result of a movement of one of the panels relative to the other. An example of this will be seen below.

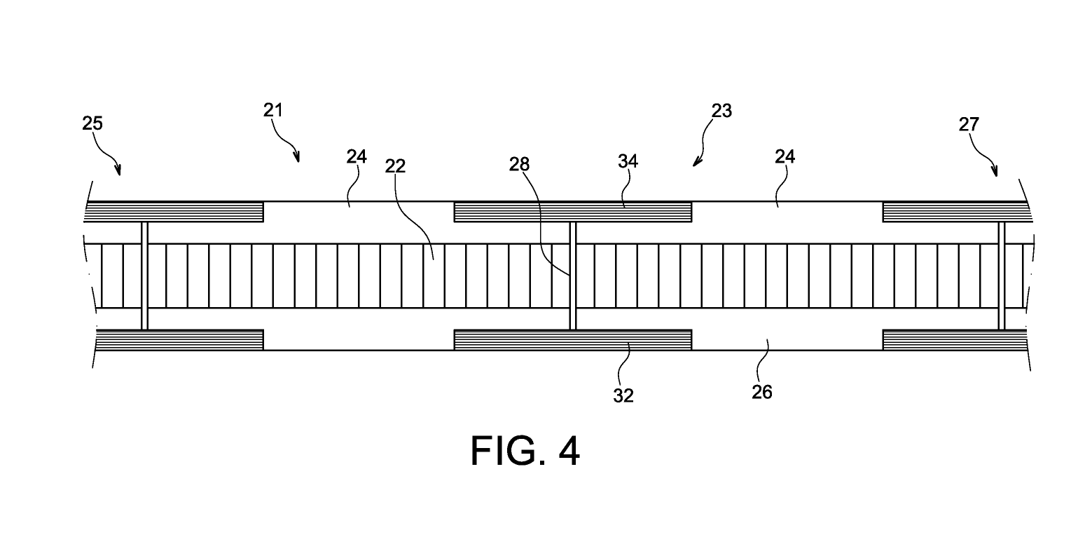

FIG. 4 represents an assembly comprising four panels 21, 23, 25, 27, of which two (21 and 23) are represented over their entire width, whereas the other two (25 and 27) are only partially represented. An assembly is not limited to four panels but can comprise n, n>4, for example n=10, or 20, or n>20. Clearly visible, also in this figure, is the presence of the reinforcing strips 32, 34, for each joining line of a panel and of an adjacent panel.

Similarly, there could be an assembly of n panels (n>3 or n>4, for example n=10, or 20, or n>20) with reinforcing strips 32, 34 positioned as indicated in FIG. 3C, that is to say without groove, being driven into the panels by pressure.

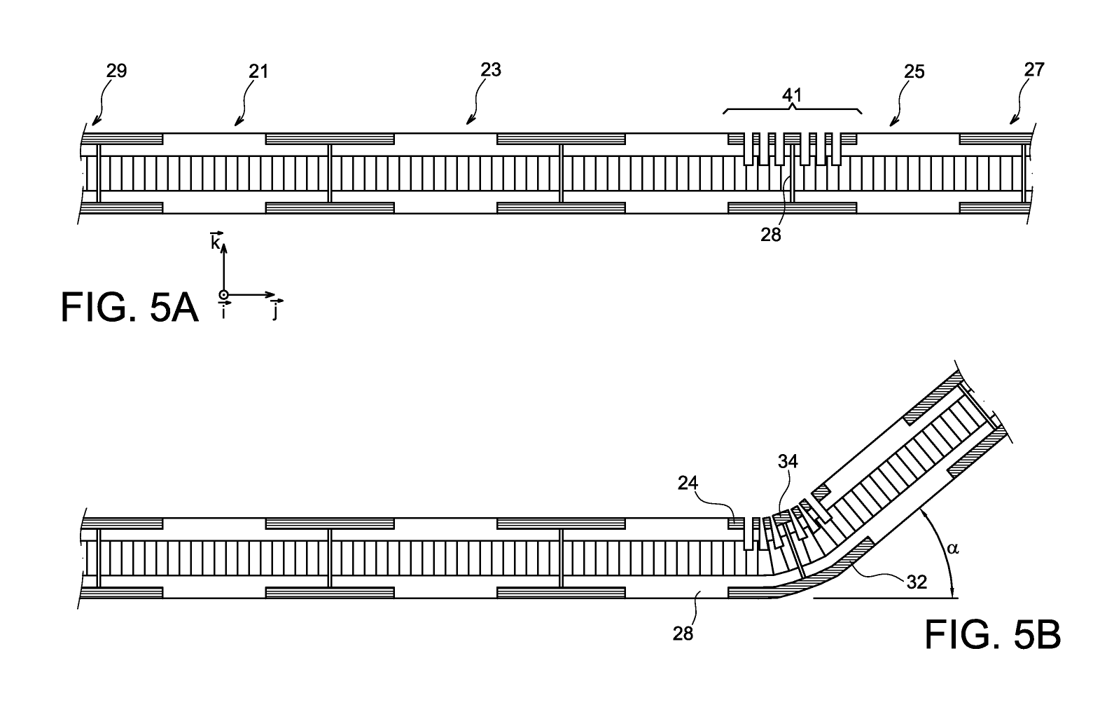

FIG. 5A represents an assembly comprising five panels 21, 23, 25, 27, 29, four of which are represented over their entire width, whereas the other two (29 and 27) are only partially represented. The presence of the reinforcing strips, for each joining line, is clearly visible. Two panels are provided with a set 41 of slots or notches, on either side of the joining line 28, over the entire length thereof. The assemblies represented all have notches, or grooves, for reinforcing strips to be introduced therein. However, once again, a structure such as that of FIG. 3C can be implemented, with neither notch nor groove.

These slots or notches have a depth, under the external surface defined by the skin 24, which can be variable, but which can be sufficient to end in the core 22 of the panels.

These slots or notches will make it possible to fold the panel, after assembly, along an axis, parallel to the axis Oi and situated along the joining zone 28.

After folding, the structure has roughly the form represented in FIG. 5B. The external surface of the skin 26 is, in the folding zone, subject to pulling forces, whereas the skin 24, for its part, is subject to a compression stress. This compression stress is at least partially absorbed by the notches 41: the walls of each notch, which are situated at a certain distance from one another while facing one another in the rest position (position represented in FIG. 5A), move closer to one another when the structure is folded, which makes it possible to substantially absorb the compression

The number, the width, the depth and the form of these notches (in a plane jk substantially perpendicular to the plane defined by the structure as a whole) depend on the folding flexibility that is desired, and on the angle α that is desired between the two faces defined by the different panels situated on either side of the set of notches. This angle α can range between a few degrees, for example 10° and 90°. It can be greater than 90°, and, for example, less than 160°, for applications in which a support surface S is required, as illustrated in FIG. 5C, in which the five panels 21, 23, 25, 27, 29 are schematically represented.

The notches 41 are represented in FIGS. 5A-5C, 6A-6B and 7, as being produced in the reinforcing zones, and parallel to a joining line 28. However, these notches can be produced in any zone of a panel according to the invention, and in any direction relative to the joining zones 28; in particular, these notches can be parallel, or perpendicular, to these joining zones.

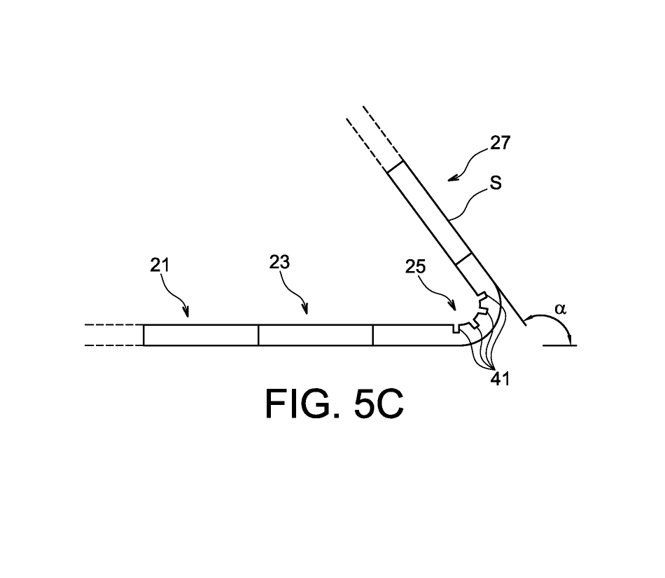

FIGS. 6A and 6B show enlarged views of the joining zone 28, with the notches 41 positioned on either side thereof. In FIG. 6A, it can be seen that the notches have a substantially flat bottom, each notch being of substantially rectangular form in a plane at right angles to the plane defined by the structure as a whole and at right angles to the welding zone 28. In FIG. 6B, each notch is roughly in the form of a triangle or of an isosceles triangle in this same plane, the vertex of the triangle being in the mass of the panel. The notches can therefore have various forms, while retaining the function described above when folding one of the two panel faces, situated on each side of the joining zone 28, relative to the other.

Different techniques can be used to eliminate skin on one of the surfaces to allow folding on a panel:
mechanical technique (machine, or cutting, punching, or grinding, etc.);
heat technique (temperature rise and indentation of the surface);
chemical technique (by chemical degradation of the material).

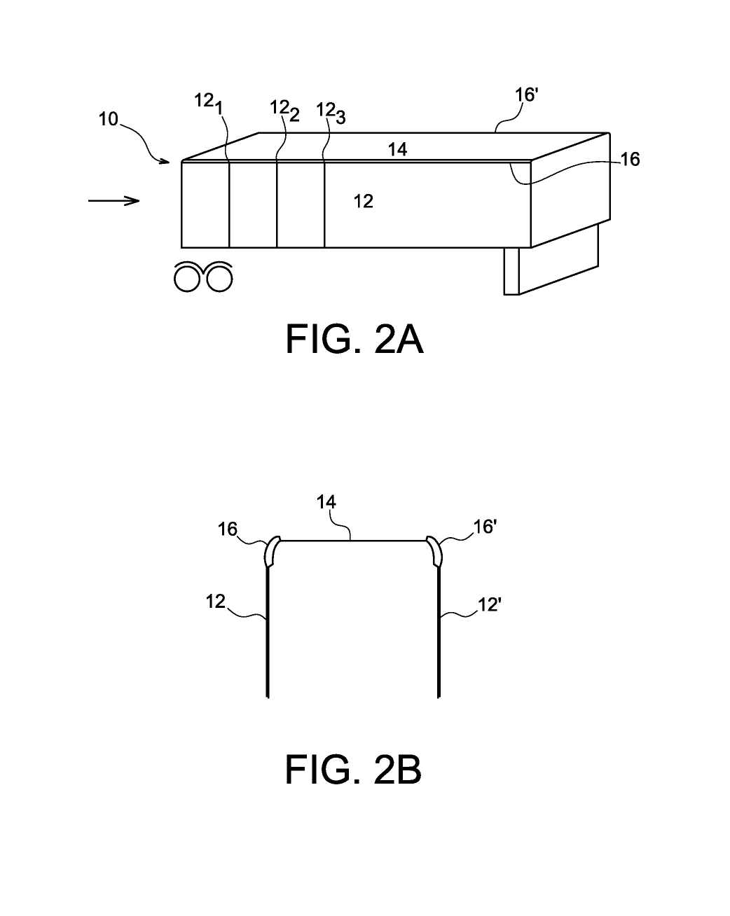

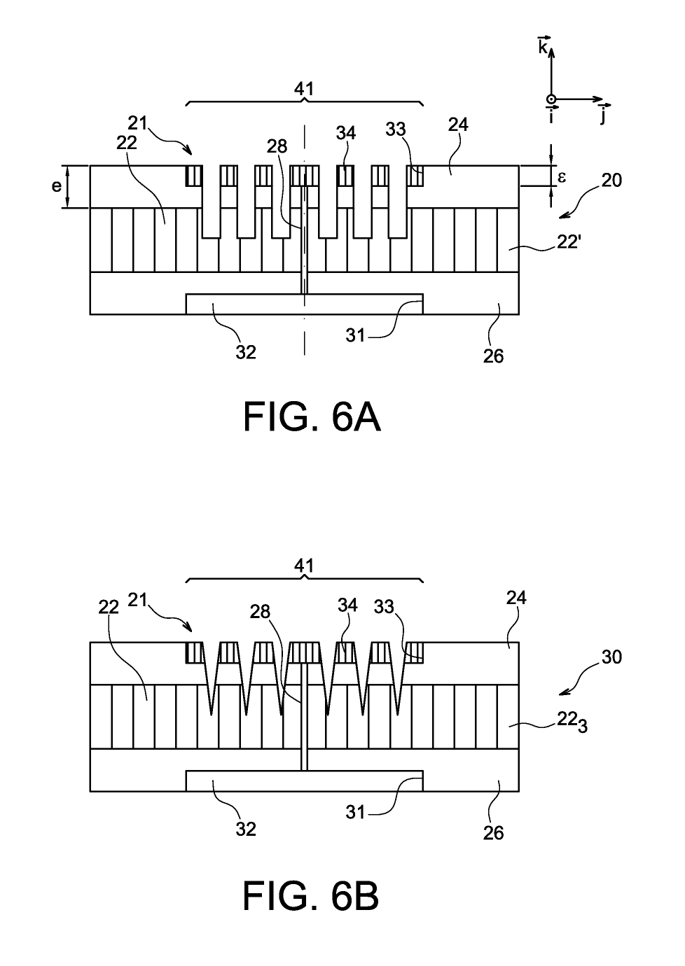

FIG. 7 shows a set of joined individual panels, with joining lines identified by the references 28₁-28₄. On either side of two of these joining lines, 28₁ and 28₃, sets of notches 41₁, 41₃ have been produced which will make it possible to produce a fold on either side of these same lines. It is therefore possible to produce a three-dimensional structure, folded along these folding zones, without needing to join panels with other elements, such as, for example, the angle brackets 16, 16′ of FIGS. 2A-2B.

The forms 51-54 shown by broken lines represented in FIG. 7 correspond to cuts that can be produced in the panels, depending on the use that will be made of the structure, after the latter has been folded. These cuts are preferably made before folding, the set of panels then still being in one and the same plane.

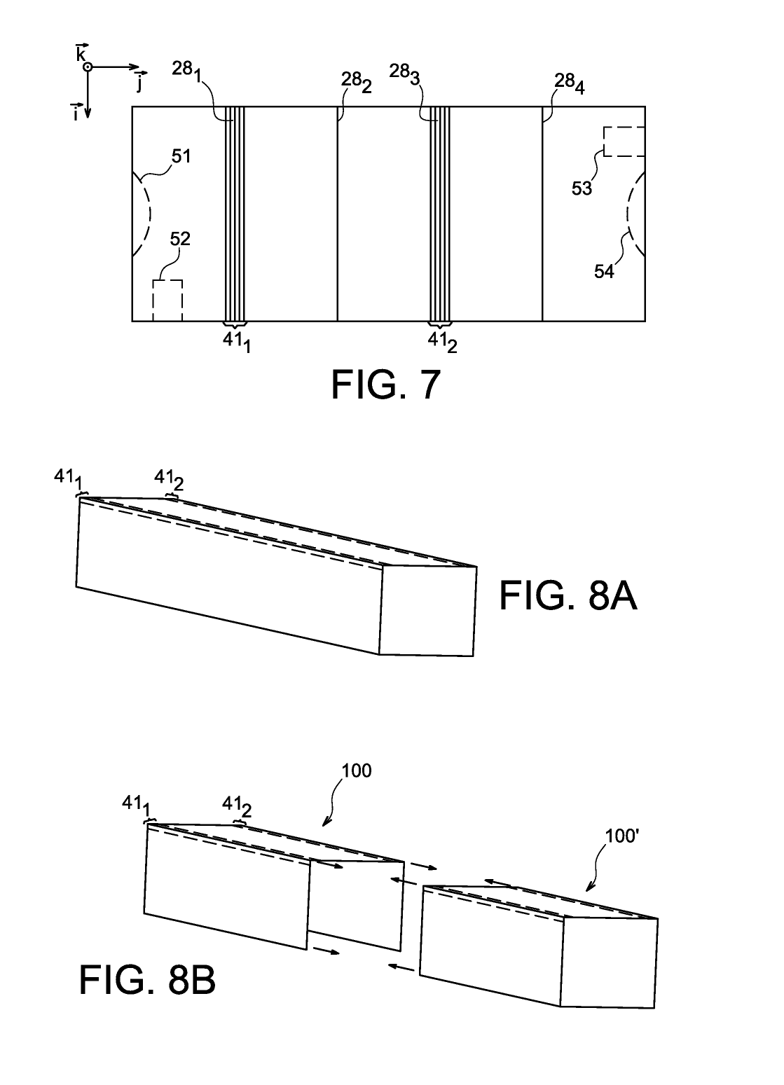

It is then possible to produce a folded structure 100 such as that of FIG. 8A, where the folding zones are identified by the references 41₁, 41₂: these are zones in which notches had been produced as has just been described. This folded structure can be that of a trailer body.

It is also possible, as represented in FIG. 8B, to join a plurality 100, 100′ of such structures, each of which is folded as explained above, for example via angle brackets or by gluing or by welding.

FIG. 9A shows an individual panel, with its core 22 and its two skins 24, 26. The structure of this panel is said to be open-edged. This is the structure that can be found in FIG. 3A: laterally, the core 22 is accessible and is not covered by any layer of material.

FIGS. 9B-9D show the production of another individual panel structure, called closed-edge structure. Starting from an open-edged individual panel, a lateral part of the core is eliminated therefrom, to leave lateral portions 24′, 26′ of the skins 24, 26 facing one another, with no core-forming material between the two. These lateral skin portions 24′, 26′ can therefore be folded laterally, as can be seen in FIG. 9C, to produce a merging of these lateral portions with the core, this step being illustrated in FIG. 9D.

There is then obtained what is called a closed-edge panel. This structure, in which the core-forming material 22 is clad by walls, makes it possible to provide an increase in rigidity compared to the open-edged structure of FIG. 9A.

Examples of panel structures that can be implemented in the context of the technique explained in the present application will now be given. However, these structures can also be used independently of the methods and of the composite panel structures (with reinforcing zones) which are described in the present application.

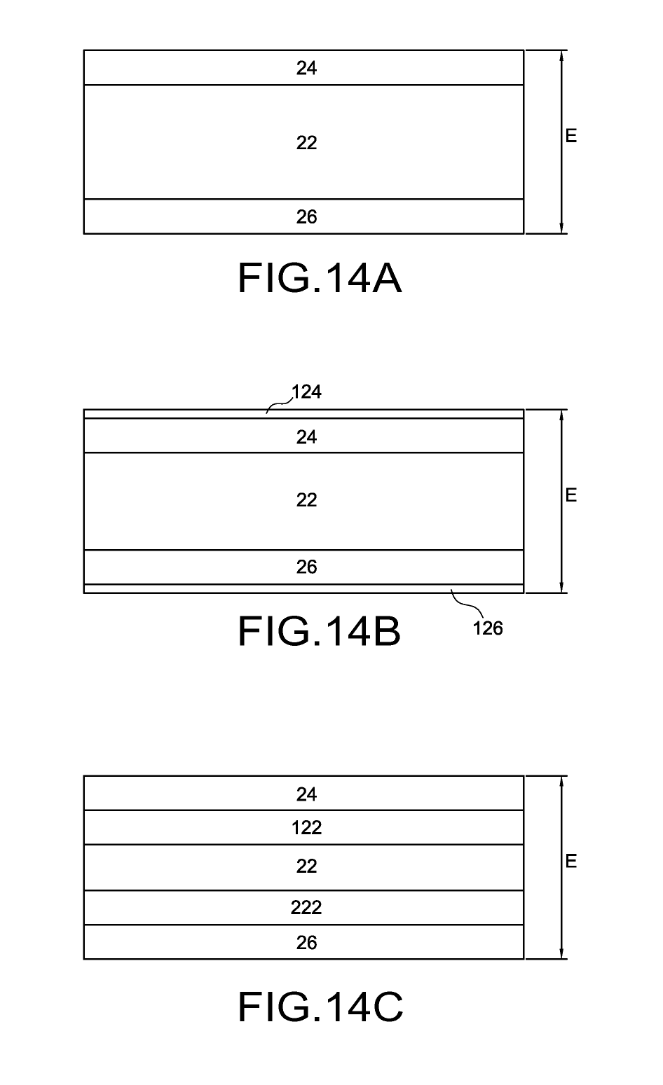

A first example relates to a panel with cellular core, for example, honeycombed, the structure of which is illustrated in FIG. 14A. This type of panel comprises:
one textile skin 24, for example of PP/glass (polypropylene (PP) reinforced with a reinforcement such as, for example, glass fiber, for example with 40% (by weight, the % are then indicated by weight) of PP and 60% of glass fibers, more generally, the skin can contain a proportion of glass fibers of between 10% and 70%).
One cellular core 22, for example honeycombed, for example of polypropylene, with a density of, for example, between 30 kg/m³ and 500 kg/m³,
one textile skin 26, for example of PP/glass (see above for this composition).

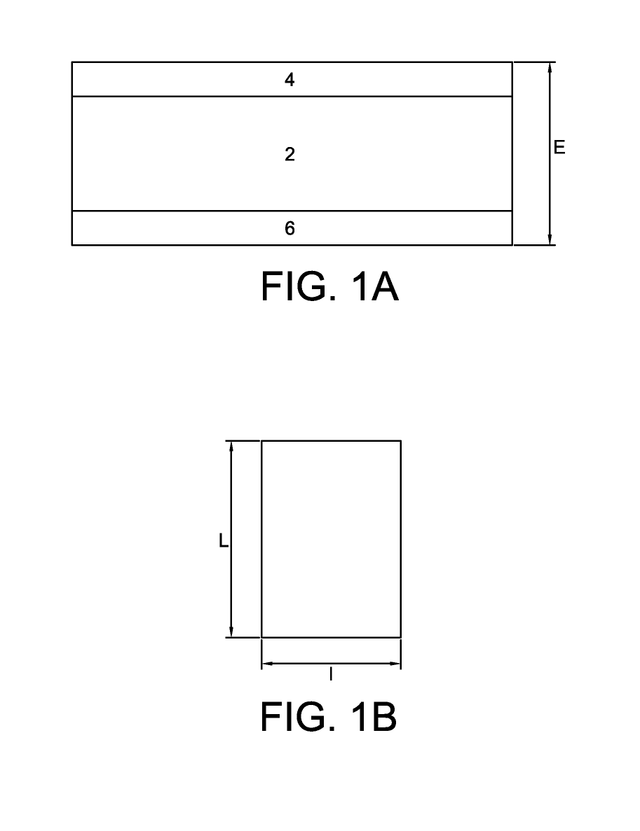

The dimensions can, for example, be as follows (the same notations are adopted in this example and in the subsequent examples as in FIGS. 1A and 1B):
thickness E between 5 and 100 mm;
width I between 500 mm and 3000 mm;
length L between 1000 and 13 500 mm.

A second example relates to a panel with polypropylene foam core (structure illustrated in FIG. 14A), which comprises:
one textile skin 24, for example of PP/glass (see above for this composition),
one core 22 of polypropylene foam, with a density of, for example, between 30 kg/m³ and 500 kg/m³;
one textile skin 26, for example of PP/glass (see above for this composition).

The dimensions of this panel can, for example, be as follows:
thickness E between 5 mm and 100 mm,
width I between 500 mm and 3000 mm,
length L between 1000 mm and 13 500 mm.

A third example relates to a panel with a monolithic polypropylene coating, the structure of which is illustrated in FIG. 14B, which comprises:
one monolithic sheet 124, for example of polypropylene,
one textile skin 24, for example of PP/glass (see above for this composition),
one cellular core 22, for example honeycombed, for example of polypropylene, with a density, for example, of between 30 kg/m³ and 500 kg/m³,
one textile skin 26, for example of PP/glass (see above for this composition),
one monolithic sheet 126, for example of polypropylene.

The role of each sheet is to provide a weight supplement for welding, and/or an improved seal-tightness and/or a non-skid external surface . . . .

It is in the textile skins 24, 26 that, if necessary, the notches or grooves 31, 33 are produced, into each of said notches or grooves it will then be possible to insert a reinforcing strip 32, 34, as explained above in conjunction with FIGS. 3A and 3B (as a variant, notches are not produced, and the reinforcing strips are positioned as explained above in conjunction with FIG. 3C).

The dimensions of this panel can be as follows:
thickness E between 5 and 100 mm,
width I between 500 and 3000 mm,
length L between 1000 and 13 500 mm.

A fourth example relates to a panel with mixed or hybrid or complex core (for example: polypropylene honeycomb+polypropylene foam), the structure of which is illustrated in FIG. 14C, which comprises:
one textile skin 24, for example of PP/glass,
one foam core 122, for example of polypropylene (with a density, for example, of between 30 kg/m³ and 500 kg/m³),
one cellular core 22, for example honeycombed, for example of polypropylene,
one foam core 222, for example of polypropylene (see above for density),
one textile skin 26, for example of PP/glass (see above for this composition).

Such a structure exhibits very good mechanical and thermal properties. Each of the cores 122, 222 has a thickness which can be, for example, between 3 mm and 5 mm. These two parts of the core contribute to enhanced thermal efficiency, the mechanical strength of the assembly being mainly provided by the central core 22, but also by the reinforcing strips 32, 34, which can be positioned in optional notches or grooves 31, 33. The latter will be produced in the textile skins 24, 26. Into each of these notches, it will then be possible to insert a reinforcing strip 32, 34, as explained above in conjunction with FIGS. 3A and 3B. If there are no notches, the reinforcing strips are positioned as explained above in conjunction with FIG. 3C.

The dimensions of this panel can be as follows:
thickness E between 5 mm and 100 mm,
width I between 500 mm and 3000 mm,
length L between 1000 mm and 13 500 mm.

Each of above panel examples can be manufactured either with so-called “open” edges or with so-called “closed” edges, as already explained above in conjunction with FIGS. 9A-9D.

An example is given below of how to carry out a method for joining composite panels.

The following steps are carried out:
joining of the individual panels;
elimination of the flash resulting from the preceding operation and, if necessary, the forming of grooves in the skins; it is also possible not to produce grooves, with a view to an assembly such as that of FIG. 3C;
insertion of reinforcing elements or strips, into the grooves (if present) in the skins, by pressure, then fixing of these reinforcing elements or strips, for example by thermofusion, including in the case of FIG. 3C.

If notches such as the notches 41 of FIGS. 5A-6B have to be produced, they are preferably only produced then, after the forming of the reinforcements.

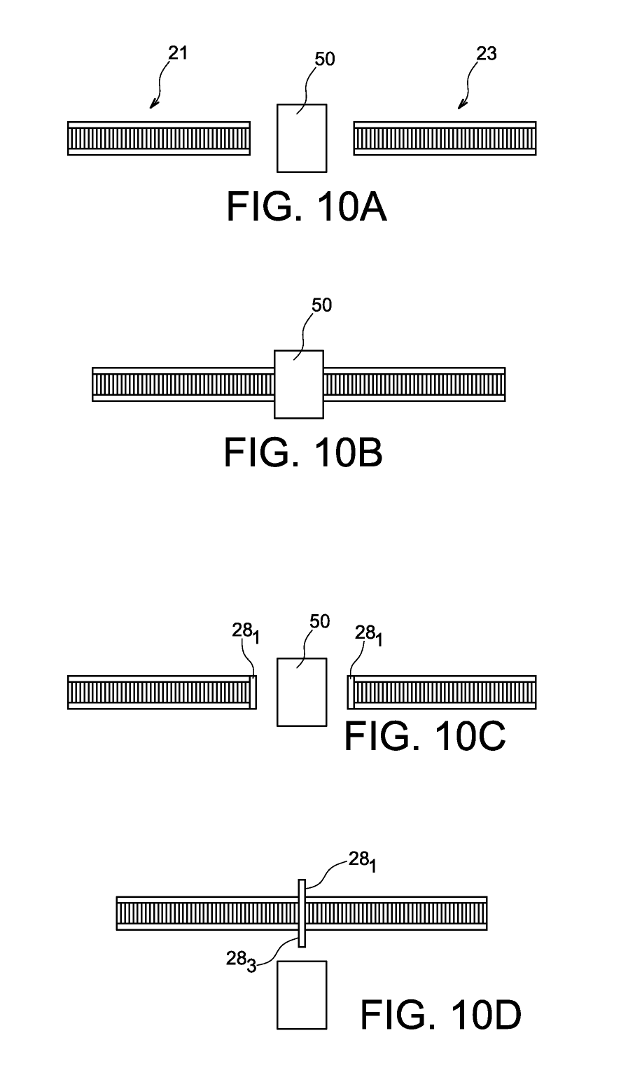

The description begins with an explanation of how two panels can be welded, in conjunction with FIGS. 10A-10D.

For this, two panels 21, 23 are welded together, by their two sides, edge to edge, with no intermediate element between two adjacent edges to be joined, by raising the temperature of each edge of the panels to be welded: for example, a lateral portion of each of the panels 21, 23 is placed in contact with a heating element 50 (FIGS. 10A and 10B). The two panels are then separated from the heating element: on the edges which have been in contact with the latter, a part 22₁, 22₃ of the material forming the core 22, is now molten. The molten portions are placed in contact with one another (FIG. 10D), then the assembly is cooled. A structure consisting of the two panels 21, 23 is therefore obtained, linked by a welding zone 28 of which a portion can extend beyond, in the form of flash 28₁, 28₃, each side of the joined assembly.

They can be panels of any of the types explained above, in conjunction with FIGS. 14A-14C.

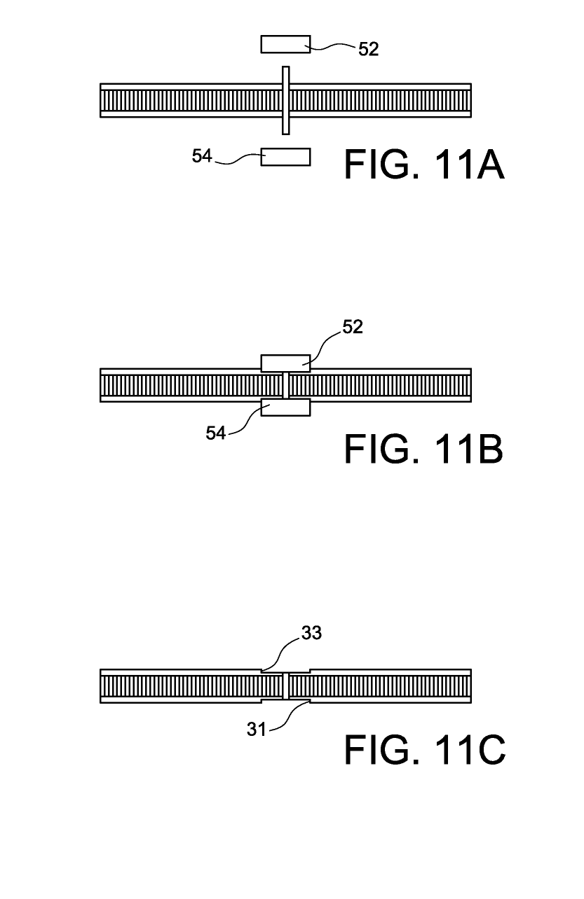

An operation of deflashing of the welds can then be carried out (FIGS. 11A-11C), on each side of the structure using a tool, for example a milling cutter 52, 54, to eliminate, on each of the faces, the flash 28₁, 28₃ generated by the welding operation (FIGS. 11A-11B). During this operation, it is also possible to produce (FIG. 11C), preferably with the same tool 52, 54, a groove 31, 33 in each of the skins, each of these grooves being, as already explained above in conjunction with FIGS. 3A and 3B, centered on the weld 28 and of a depth which can, for example, be approximately equal to a half-thickness of the skin.

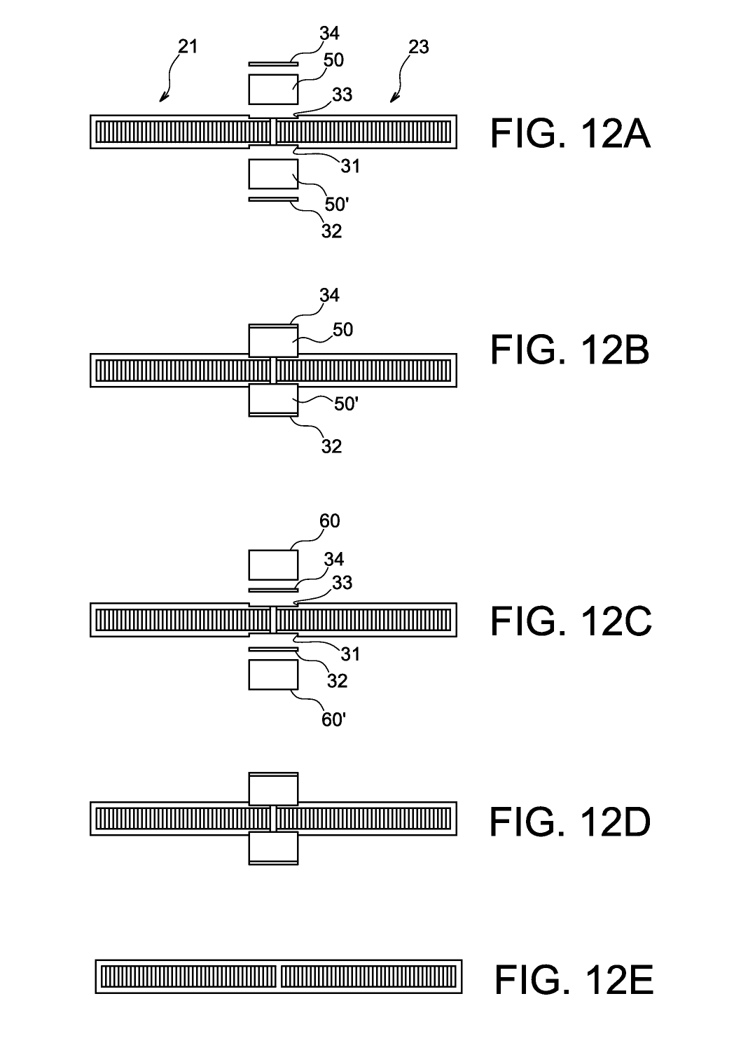

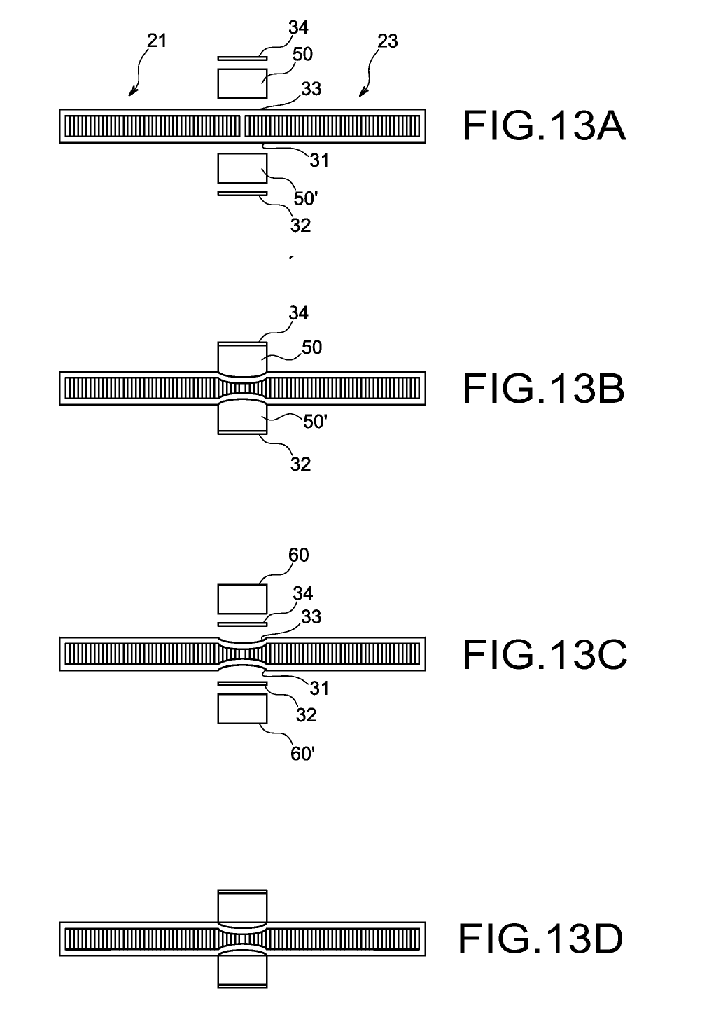

A reinforcing of the welds can be obtained using one or more strips (preferably: one on each face) of textile, as illustrated in FIGS. 12A-12E and as already explained above in conjunction with FIGS. 3A-3B or as illustrated in FIGS. 13A-13E and as already explained above in conjunction with FIG. 3C. This textile strip is, for example, of polypropylene reinforced with glass fibers.

In FIGS. 12A and 12B, heating elements 50, 50′ are placed in contact with the grooves 31, 33 which have previously been formed.

Similarly, the heating elements are placed in contact with reinforcing strips 32, 34, intended to be inserted into the grooves 31, 33. Preferably, the heating element simultaneously heats a groove 31 (respectively 33) and the strip of material 32 (respectively 34) intended to be inserted therein.

The heating elements are then moved away, and the strips of material 32, 34 are positioned facing the groove 31, 33 into which each has to be inserted.

Means or elements 60, 60′ can then be brought close in order to cool the material of these strips 32, 34 (FIG. 12C). The latter are placed in contact with the corresponding grooves and pressed against the bottom thereof using means 60, 60′ (FIG. 12D). The result of this is a structure such as that of FIG. 12E, which corresponds, in a more detailed manner, to that of FIG. 3B.

Another implementation of a method according to the invention is explained in conjunction with FIGS. 13A-13D.

This implementation starts with an assembled structure, such as that of FIG. 10D, which can have undergone an optional step for eliminating flash 28₁, 28₂ (but, this time, grooves 31, 33 are formed).

In FIGS. 13A and 13B, heating elements 50, 50′ are placed in contact with the skin surfaces, at the point where the reinforcing strips 32, 34 will be positioned.

Similarly, the heating elements are placed in contact with these reinforcing strips 32, 34. Preferably, the heating element simultaneously heats the reinforcing strip 32, 34 and the part of the surface of one of the skins on which this same strip of reinforcing material 32, 34 has to be positioned. During this step, a pressure can be exerted to begin to “indent” the corresponding zones of the skins toward the interior of the panels.

The heating elements are then moved away, and the strips of materials 32, 34 are positioned on the zones of the skins on which, or in which, these strips have to be inserted.

Means or elements 60, 60′ can then be close in order to cool the material of these strips 32, 34 (FIG. 13C). Here again, a pressure can be exerted to press on the strips in order to position them in the skins, as illustrated in FIG. 3C. The strips are therefore pressed using means 60, 60′ (FIG. 13D). The result of this is a structure such as that of FIG. 13D, which corresponds, in a more detailed manner, to that of FIG. 3C.

In this embodiment, the flush positioning of each strip with the panels is produced by applying a pressure during the phase of heating and cooling of the surfaces.

An implementation using a technology of heating by contact with the strips and the panels has been described above, but there are other possible heating techniques.

It is notably possible to implement a heating technique which does not involve any contact, for example using infrared lamps.

The method described above in conjunction with FIGS. 10A-10C then proceeds in the same way, except for the placing of the heating element 50 in contact with each of the panels 21, 23, that is replaced by a heating of the edges of each of the panels by a contactless technique, by, for example, directing the radiation from one or more infrared lamps toward these edges.

The methods described above in conjunction with FIGS. 12A-12E and 13A-13D also proceed in the manner already described above, except for the heating technique: the panels and/or the reinforcing strips are no longer placed in direct contact with a heating element 50, 50′, but these elements are heated by a contactless technique, for example one or more infrared lamps. In the case of FIGS. 13A-13D, the pressure, which will make it possible to indent the zones of the skins toward the interior of the panels, is exerted by a tool other than the heating element.

In the case of the structure of FIG. 14B, the assembly can then be covered with the sheets 124, 126.

Mechanical tests were carried out, these tests were conducted with the measurements given in table I below.

The first features involve comparing the flexural behavior of specimens taken during standard manufacture and specimens of panels joined according to the method detailed previously.

The single-panel structure is a structure of the type of FIG. 14A, with a honeycomb core 22, consisting of 60 kg/m³ to 200 kg/m³ (for example 80 kg/m³) polypropylene, provided with skins 24, 26, of polypropylene/glass, 40% PP and 60% glass, the long fibers being oriented 0-90. These panels are reinforced with a strip 32, 34.

The structure of the panels joined according to the invention is identical.

TABLE I

| | Increase in flexural |
|---|---|
| Panel type | modulus |
| Single panel (without assembly or closed edge) | 100% |
| Panels joined according to the invention with | 184% |
| “open” edges | |
| Panels joined according to the invention with | 200% |
| “closed” edges | |

Table I highlights the fact that the panel joining technology described above considerably enhances the flexural characteristics of the thermoplastic composite panels.

The teaching of the present application, regarding both the production method and the panels themselves, therefore makes it possible to achieve a significant reinforcement of the panels, as well as a much more flexible use than the panels currently known.

1. A composite panel, comprising:
a plurality of individual composite panels, each comprising at least one core and two surface skins positioned on either side of the core, and each being heat welded along a joining zone for joining with at least one adjacent individual panel by one of its sides,
an indented zone, or recessed zone, formed in the surface skins, on either side of the joining zone and along the latter,
a strip of reinforcing material positioned on said joining zone joining a panel with the adjacent panel or panels, in each indented, or recessed, zone.

2. The composite panel as claimed in claim 1, in which the core of an individual composite panel comprises at least one layer of cellular material.

3. The composite panel as claimed in claim 1, in which the core of an individual composite panel comprises at least one layer of polypropylene foam.

4. The composite panel as claimed in claim 1, in which the core of an individual composite panel is hybrid, comprising at least two layers of different natures.

5. The composite panel as claimed in claim 4, the core comprising a first layer of foam, a second honeycomb layer, and a third layer of foam.

6. The composite panel as claimed in claim 1, also comprising external sheets, for example of polypropylene, covering the skins and the strips of reinforcing material.

7. The composite panel as claimed in claim 1, in which the surface skins are of textile or of reinforced polypropylene.

8. The composite panel as claimed in claim 1, in which:
the external surface of the reinforcing strips is flush with the external surface of the adjacent panels,
or else in which the external surface of the strips of reinforcing materials is raised relative to the external surface of the adjacent panels.

9. The composite panel as claimed in claim 1, also comprising at least one notch, formed at least in a reinforcing strip, this notch forming at least one folding zone and making it possible to fold the panel according to the direction of this notch.

10. The composite panel as claimed in claim 9, at least one notch being positioned in a direction parallel, or in a direction perpendicular to said strips of reinforcing material.

11. The composite panel as claimed in claim 1, comprising at least one folding or curving or bending zone, each comprising at least one notch formed at least in a reinforcing strip and positioned in a direction parallel to said strips of reinforcing material.

12. The composite panel as claimed in claim 1, having:
a width, measured in a direction parallel to the strips of reinforcing material, of between 0.5 m and 5 m or 10 m;
and/or a length, measured in a direction perpendicular to the strips of reinforcing material, of between 1 m and 20 m and/or at least equal to 5 m or 10 m;
and/or a thickness, measured between the external surfaces of the surface walls, of between 5 mm and 100 mm.

13. The composite panel as claimed in claim 1, each individual panel having open edges or closed edges.

14. The composite panel as claimed in claim 1, each indented, or recessed, zone:
comprising a groove formed in the corresponding skin;
or resulting from the penetration of a portion of skin into the core, the thickness of the corresponding portion of the core being reduced relative to the adjacent zone or zones not having undergone this penetration.

15. A method for manufacturing a composite panel comprising:
a)—joining a plurality of individual composite panels, each comprising at least one core and two surface skins, each panel being joined with at least one adjacent individual panel by heat welding, by one of its sides,
b)—fixing at least one strip of reinforcing material on each joining zone joining a panel with the adjacent panel or panels, in one or more indented, or recessed, zones of the panel.

16. The method as claimed in claim 15, comprising the formation of a groove in the surface skins, on either side of a joining zone and along the latter, said strip of reinforcing material being fixed in said groove.

17. The method as claimed in claim 15, comprising the formation of an indented, or recessed, zone by the application of a pressure on the portion of the panel which has to receive said strip of reinforcing material.

18. The method as claimed in claim 17, comprising, before the fixing step b), a step of heating each individual composite panel, in the parts in which the indented, or recessed, zones are to be produced, and applying a pressure from the external surface of the panel toward the core.

19. The method as claimed in claim 18, in which the strip of reinforcing material is also heated, before the fixing step b).

20. The method as claimed in claim 15, the step fixing b) being performed by thermo-fusion or thermo-welding.

21. The method as claimed in claim 15, also comprising the formation of at least one notch in at least one of the panels, this notch making it possible to fold the panel according to its direction.

22. The method as claimed in claim 15, also comprising a step of eliminating flash after joining the panels.

22. The method as claimed in claim 15, also comprising the elimination of a zone of material in at least one of the individual panels.

23. A method for producing a three-dimensional shape comprising a plurality of composite panels, comprising the implementation of a method as claimed in claim 22, followed by a step of folding along at least one of said notches.

24. The method as claimed in claim 22, also comprising a step of eliminating flash after joining the panels.

25. The method as claimed in claim 22, also comprising the elimination of a zone of material in at least one of the individual panels.
